(19) United States
(12) Patent Application Publication
(10) Pub. No.: US 2004/0118260 A1
(43) Pub. Date: Jun. 24, 2004

(54) Sheet cutter for making business cards

(76) Inventors: Shui-Yi Lee, Hsintien City (TW); Jack Lee, Panchiao City (TW)

Correspondence Address: Morton J. Rosenberg, Esq., Rosenberg, Klein & Lee, Suite 101, 3458 Ellicott Center Drive, Ellicott City, MD, 21043, US

(21) Appl. No.: 10/698,444

(22) Filed: Nov. 3, 2003

(30) Foreign Application Priority Data
Nov. 6, 2002 (TW) 091217813

(51) Int. Cl. B26D 1/24

(52) U.S. Cl. 83/469; 83/508.1

(57) ABSTRACT

A sheet cutter for making business cards is composed of an upper cover, a seat mounted beneath the upper cover, a transversal blade assembly and a longitudinal blade assembly. By using the transversal blade, a sheet printed with multiple business card details in rows and columns can be conveniently cut into individual business cards along the longitudinal and transversal directions.

### BACKGROUND OF THE INVENTION

1. Field of the Invention

The present invention relates to a paper cutter, and more particularly to a business card sheet cutter.

2. Description of Related Art

It is very common for a person to give out a business card printed with job and company details to a recipient. In manufacturing, a large sheet is printed with multiple business cards arranged in several rows and columns, and cut into individual business cards by a sheet cutter.

A conventional sheet cutter for the manufacturing of business cards can only cut the sheet longitudinally into several strips of business cards. Thus, the strips must be further cut manually or by other cutting means into the individual business cards, thus it is very inconvenient to manufacture the business card by using the conventional sheet cutter.

Therefore, the invention provides a sheet cutter to mitigate or obviate the aforementioned problems.

### SUMMARY OF THE INVENTION

The main objective of the present invention is to provide a sheet cutter for making business cards which can longitudinally and transversally cut the sheet into individual business cards.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a sheet cutter in accordance with the invention;

FIG. 2 is a sectional side view of the sheet cutter in accordance with the invention;

FIG. 3 is a perspective view of a seat of the sheet cutter;

FIG. 4 is a partial perspective view of a transversal blade assembly of the sheet cutter;

FIG. 5 is a partial top view of the sheet cutter;

FIG. 6 is a partially exploded perspective view of a knob of the sheet cutter; and

FIG. 7 is a schematically top view showing business cards cut by the sheet cutter in accordance with the invention.

### DETAILED DESCRIPTION OF THE PREFERRED EMBODIMENT

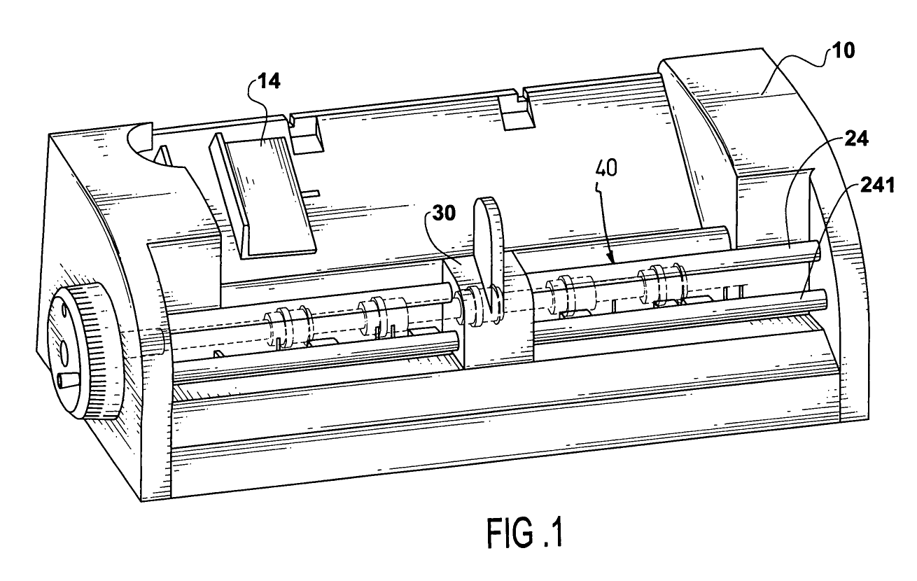

With reference to FIGS. 1-3, a sheet cutter for making business cards in accordance with the invention is composed of an upper cover (10), a seat (20), a transversal blade assembly (30), and a longitudinal blade assembly (40).

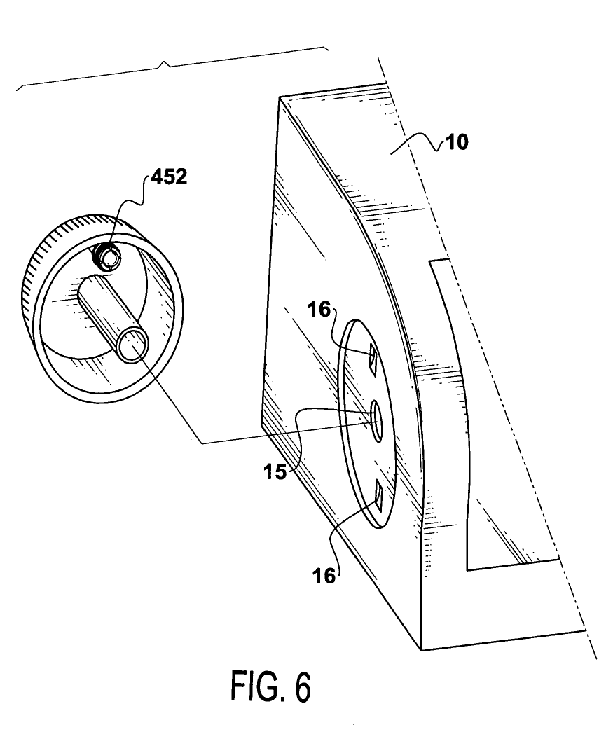

The upper cover (10) has a front side, a rear side and two side portions (not numbered). A paper dispenser (12) is formed between the two side portions and the rear side of the upper cover (10), and an adjusting stop (14) is formed on the paper dispenser (12). A U-shaped notch (not numbered), viewed from the top, is defined between the two side portions and at the front side of the upper cover (10). A shield (11) is formed between the paper dispenser (12) and the U-shaped notch, and a gap (13) is defined between the shield (11) and the paper dispenser (12). An axle hole (15) is transversally defined through one of the side portions and two positioning recesses (16) are defined at two diametrically opposite sides of the axle hole (15), as shown in FIG. 6.

With reference back to FIGS. 1-3, the seat (20) is mounted beneath the upper cover (10), and has two ears (23) mounted at two sides of the seat (20). A first shaft (24) and a second shaft (241) are transversally installed between the ears (23) and revealed from the U-shaped notch. Two walls (211) are respectively formed at rear ends of the ears (23) and a slot (21) is transversally defined between the walls (211) and parallel to the shafts (24, 241). A groove (22) is transversally defined between the slot (21) and the shafts (24, 241).

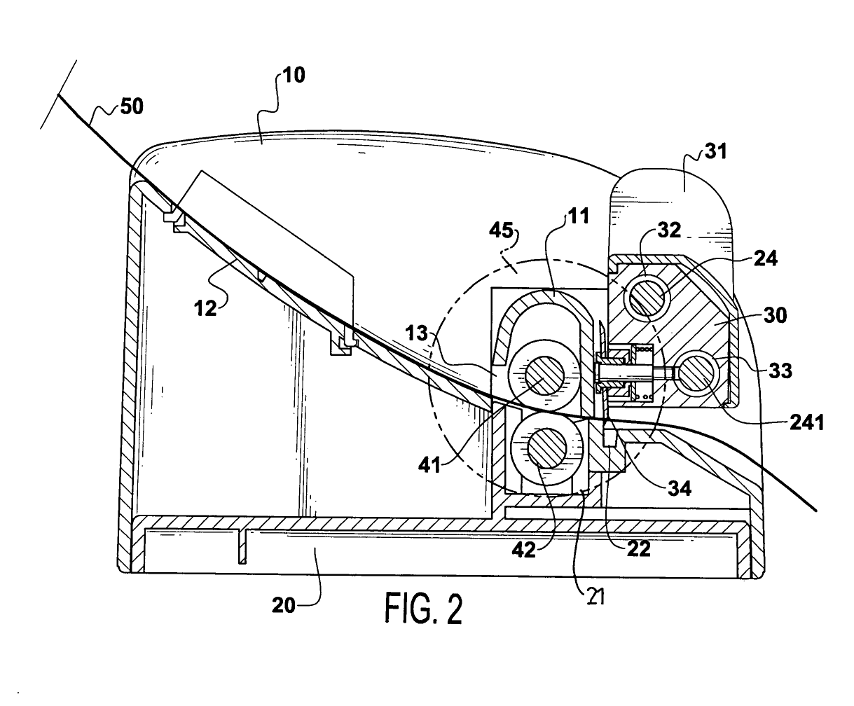

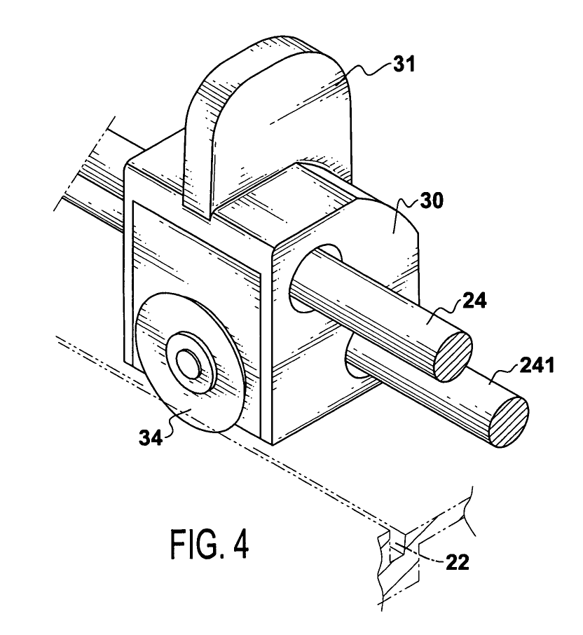

The transversal blade assembly (30) has a blade seat (not numbered) movably mounted on the shafts (24,241). The blade seat has a first shaft hole (32) and a second shaft hole (33) defined therethrough, and the shafts (24, 241) respectively extend through the shaft holes (32, 33). A handle (31) is formed at a top of the blade seat. A circular blade (34) is mounted at a rear side of the blade seat and received in the groove (22) and abuts an inner wall of the groove (22), as specially shown in FIGS. 2 and 4.

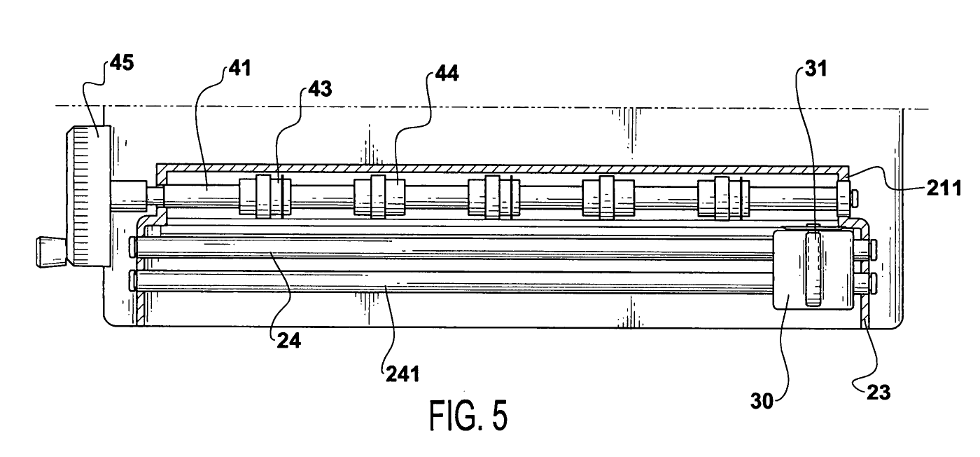

With reference to FIGS. 1, 2, 3, and 5, the longitudinal blade assembly (40) has an upper axle (41) and a lower axle (42) mounted between the walls (211), wherein the upper axle (41) is concealed by the shield (11) and mounted above the slot (21), and the lower axle (42) is received in the slot (21). Multiple ring blades (43) are provided in pairs outside the upper axle (41) and the lower axle (42). Multiple sleeves (44) are provided in pairs outside the upper axle (41) and the lower axle (42) and respectively between each two pairs of the ring blades (43). The ring blades (43) and sleeves (44) on the upper axle (41) respectively abut the corresponding ring blades (43) and sleeves (44) on the lower axle (42).

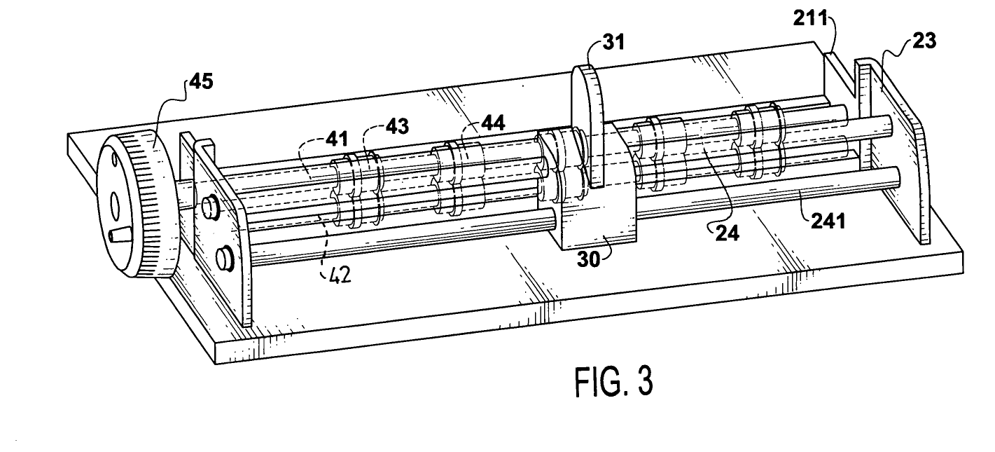

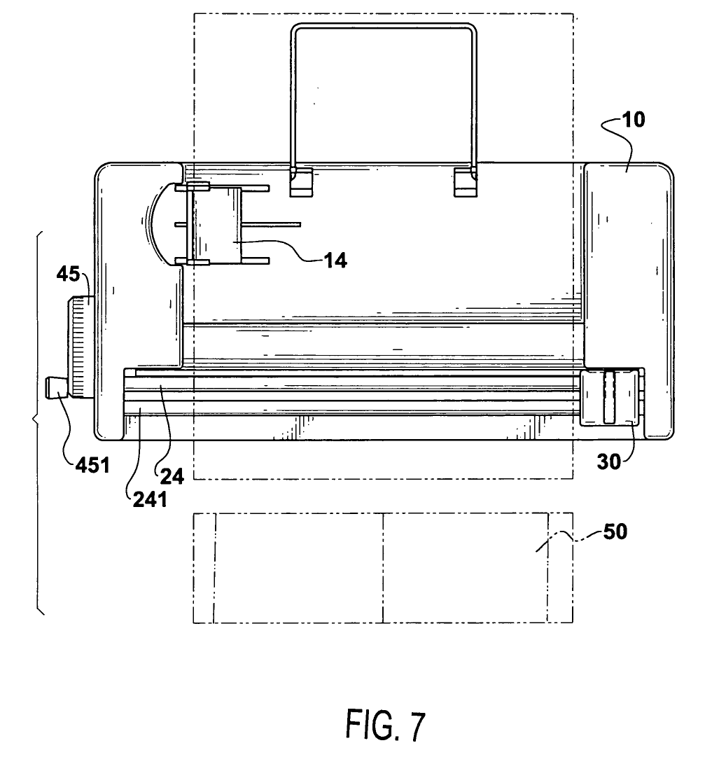

With reference to FIGS. 3, 6 and 7, a knob (45) is provided at an end of the upper axle (41), and has a lug (451) formed at an exterior surface thereof and a pole (452) formed at an interior surface thereof and engaged in one of the positioning recesses (16).

With reference to FIGS. 1 and 2, in making business cards, a sheet (50) is disposed on the paper dispenser (12) and the adjusting stop (14) is adjusted to position the sheet (50). A front end of the sheet (50) will pass through the gap (13) and be located between the first axle (41) and the second axle (42). When a user turns the knob (45) to rotate the first axle (41), the second axle (42) is driven by the first axle (41) to rotate in an opposed direction, and the sheet (50) is pulled by the sleeves (44) and longitudinally cut by the ring blades (43).

With reference to FIG. 6, when the pole (452) is engaged in the other positioning recess (16), the sheet (50) is just cut with a length corresponding to a width of a business card. Then, the user can hold the handle (31) to move the transversal blade assembly (30) along the first shaft (24) and the second shaft (241), and the sheet (50) is transversally cut by the circular blade (34) to complete the business cards with desired sizes.

In the preferred embodiment, the ring blades (43) and the sleeves (44) can be moved along the first and second axles (41, 42) to adjust the distances between ring blades (43) corresponding to the width of the individual business cards.

Therefore, according to the present invention, using the sheet cutter can longitudinally and transversally cut individual business cards in one time, which is very convenient to make the business cards.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A sheet cutter for making business cards comprising:
an upper cover having a front side, a rear side, two side portions, and a U-like notch defined at the front side;
a seat mounted beneath the upper cover, the seat having two ears respectively mounted at two sides of the seat, a first shaft and a second shaft mounted between the ears and parallel to each other and revealed from the U-like notch, two walls respectively formed at rear ends of the ears, and a slot defined between the walls;
a transversal blade assembly having a blade seat movably mounted on the first shaft and second shaft and a circular blade mounted at a rear side of the blade seat; and
a longitudinal blade assembly having a first axle and a second axle mounted between the walls and parallel to each other, wherein the first axle is above the slot and the second axle is received in the slot, multiple ring blades in pairs provided outside the first axle and second axle, and multiple sleeves in pairs provided outside the first axle and second axle and respectively between each two adjacent ring blades.

2. The sheet cutter as claimed in claim 1, wherein the seat further has a groove parallel to the slot and between the slot and the first and second axles, and the circular blade is located in the groove.

3. The sheet cutter as claimed in claim 1, wherein the transversal blade assembly further has a handle formed at a top of the blade seat.

4. The sheet cutter as claimed in claim 1, wherein the upper cover further has a paper dispenser provided at a rear side and between the side portions of the upper cover.

5. The sheet cutter as claimed in claim 4, wherein the upper cover further has a shield formed between the paper dispenser and the U-like notch, and a gap defined between the paper dispenser and the shield.

6. The sheet cutter as claimed in claim 4, wherein the upper cover has an adjusting stop formed on the paper dispenser.

7. The sheet cutter as claimed in claim 1 further comprising a knob provided at an end of the first axle.

8. The sheet cutter as claimed in claim 7, wherein the upper cover has an axle hole defined through the side portion adjacent the knob, two positioning recesses respectively defined at two diametrically opposite sides of the axle hole, and the knob has a lug formed at an exterior surface of the knob and a pole formed at an interior surface and engaged in one of the positioning recesses.
